(19) United States
(12) Patent Application Publication
(10) Pub. No.: US 2005/0233088 A1
(43) Pub. Date: Oct. 20, 2005

(54) Use of separation gas in continuous hot dip metal finishing

(76) Inventors: Walter Trakowski, Duisburg (DE); Rolf Brisberger, Issum (DE)

Correspondence Address: FRIEDRICH KUEFFNER, 317 MADISON AVENUE, SUITE 910, NEW YORK, NY, 10017, US

(21) Appl. No.: 10/519,579

(22) PCT Filed: Mar. 28, 2003
(86) PCT No.: PCT/EP03/03219

§ 371 Date: Jun. 13, 2005

(30) Foreign Application Priority Data
Jun. 28, 2002 (DE) 102292035
Jul. 23, 2002 (DE) 102333432

(51) Int. Cl. B05D 1/18

(52) U.S. Cl. 427/433; 427/431

(57) ABSTRACT

The invention relates to a method for suppressing zinc evaporation in the hot dip metal coating of a steel strip with zinc or zinc alloys. According to the invention, a separation gas layer is provided above the metal bath, said gas being selected from argon, butane, krypton, propane, sulphur dioxide, hydrogen sulphide, xenon, acetylene, arsine, boron trichloride, boron trifluoride, butene, dichlorosilane, disilane, ethylene oxide, tetrafluoromethane, monochlorodifluoromethane, trifluoromethane, hexafluoroethane, tetrafluoroethene, isobutane, nitrogen dioxide, nitrogen(III) fluoride, nitrogen oxide, phosphine, propene, silane, silicon tetrafluoride, silicon tetrachloride, sulphur hexafluoride, sulphur tetrafluoride, tungsten hexafluoride, or from an arbitrary combination of the aforementioned gases to form a gas mixture with or without argon. Said gases have a poor conductivity and are suitable for preventing gaseous turbulence.

The invention concerns a method for suppressing the evaporation of zinc during the hot dip coating of steel strip with zinc or zinc alloys, wherein the metal strip is guided through a furnace snout immersed in the-metal bath, guided around a deflecting roller in the metal bath, and then emerges from the metal bath at the top.

In the continuous hot dip coating of metal strip, especially the hot dip galvanizing of metal strip, the effect of sublimation of the coating metal occurs. This is especially critical, since the sublimation also occurs in the furnace chamber of the preceding strip annealing and surface activation. A hydrogen/nitrogen atmosphere is usually present in this system. The sublimate moves back in the opposite direction from the direction of strip travel and is deposited in relatively cold places in the furnace. This effect is promoted by the presence of hydrogen. The effect is well known and with increasing sublimate formation leads to surface defects of the metal strip to be coated.

It is known from the state of the art that the addition of moisture or of carbon monoxide/dioxide can permanently inhibit and even suppress the sublimation effect.

In this regard, the document DE 44 00 886 C2 describes a method for suppressing zinc evaporation during hot dip coating of steel strip with zinc or zinc alloys, in which, in a run-in area, the steel strip is under a protective atmosphere that consists of a mixture of an inert gas with hydrogen and/or carbon monoxide as reducing gases and, in addition, carbon dioxide. The protective gas atmosphere should contain up to 20 vol. %. of hydrogen and up to 10 vol.% of carbon monoxide, or 0.05 to 8 vol. % of CO₂ should be mixed with the protective gas atmosphere.

The document EP 0 172 681 B1 describes a method for suppressing the formation of zinc vapors in a continuous process for the hot dip coating of an iron-based metal strip with zinc or zinc alloys, in which the strip is enclosed in a run-in area. Water vapor is introduced into this run-in area to maintain an atmosphere that oxidizes the zinc vapors but does not oxidize the iron strip and contains at least 264 ppm of water vapor and at least 1 vol. % of hydrogen. The atmosphere in the run-in area should more preferably contain 1-8 vol. % of hydrogen and 300-4,500 vol.ppm of water vapor, and the mixture is adjusted with an inert gas, e.g., nitrogen.

However, the gases or gas mixtures used in the state of the art also cause oxidation of the surface of the metal strip, which makes it more difficult to produce coatings with no defects. This problem, especially in the presence of moisture, is sufficiently well known in the production of hot dip galvanized metal strip.

The invention is based on the recognition that the amount of sublimate formation is affected by the turbulence of the gas above the surface of the metal strip and by its thermal conductivity. The problem, therefore, is to find a gas that has poor thermal conductivity and accumulates above the metal bath and thus eliminates turbulence.

Based on this recognition, the objective of the invention is to suppress the formation of sublimate and to ensure defect-free coating independently of the supplied amount of sublimate-preventing gas.

To achieve this objective, it is proposed that a gas or gas mixture be present in the furnace snout above the metal bath as an isolating gas, which has poor thermal conductivity, a density <2 kg/m³, and the property of being capable of reducing or eliminating turbulence of the gas or gas mixture above the surface of the metal bath. Besides the gases specified above, such as carbon dioxide and water vapor (moisture), this can be accomplished with a noble gas, e.g., argon, as an isolating gas that has both properties. The advantage of argon is that it has both a sufficiently high density (low turbulence) and lower thermal conductivity than the nitrogen that is otherwise used. In addition, as a noble gas, it is nonoxidizing. The use of the following gases as isolating gases is also possible: butane, propane, sulfur dioxide, hydrogen sulfide, and other gases, such as acetylene, arsine, boron trichloride, boron trifluoride, butene, dichlorosilane, disilane, ethylene oxide, tetrafluoromethane, monochlorodifluoromethane, trifluoromethane, hexafluoroethane, tetrafluoroethene, isobutane, nitrogen dioxide, nitrogen trifluoride, nitric oxide, phosphine, propylene, silane, silicon tetrafluoride, silicon tetrachloride, sulfur tetrafluoride, and tungsten hexafluoride. The aforementioned gases can also be combined to form a gas mixture, with or without argon, for use as the isolating gas, as long as this gas mixture satisfies the conditions of the invention.

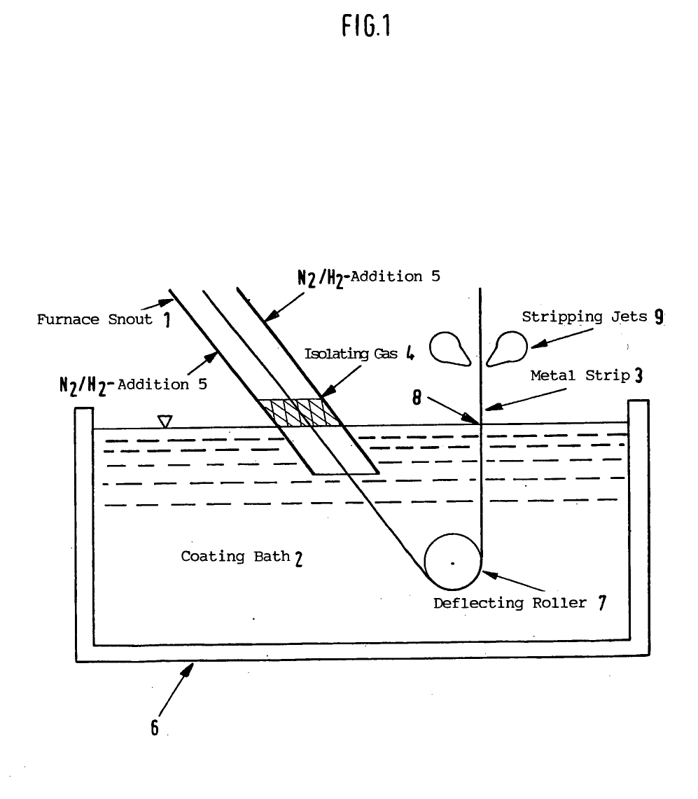

The invention is illustrated schematically in FIG. 1.

It is evident from the drawing that one of the specified gases, e.g., argon, is used in such a way that large amounts of gas for injection into the furnace snout 1 are not required during normal operation. The furnace snout 1, through which the metal strip 3 to be coated is guided, is obliquely immersed in the metal bath 2 within the coating tank 6. The metal strip 3 enters the metal bath or coating bath 2, is deflected by the deflecting roller 7, and emerges from the metal bath at 8. Stripping jets 9 are installed above the point of emergence. In the furnace snout 1, above the metal bath, there is a layer of isolating gas, e.g., argon, which serves as an isolating gas between the surface of the metal bath 2 and the customarily used gas mixture 5, which consists of nitrogen and hydrogen. The use of an isolating gas greatly reduces or completely eliminates zinc sublimation in continuous hot dip coating.

1. method for suppressing the evaporation of zinc in the hot dip coating of steel strip (3) with zinc or zinc alloys, wherein the metal strip (3) is guided through a furnace snout (1) immersed in the metal bath (2), guided around a deflecting roller (7) in the metal bath (2), and then emerges from the metal bath (2) at the top, wherein a gas or gas mixture is present in the furnace snout (1) above the metal bath (2) as an isolating gas (4), which has poor thermal conductivity, a density <2 kg/m3 and the property of being capable of reducing or eliminating turbulence of the gas or gas mixture above the surface of the metal bath:

2. Method in accordance with claim 1, wherein a hydrogen/nitrogen atmosphere is present above the layer of isolating gas.

3. Method in accordance with claim 1, wherein argon is used as the isolating gas.

4. Method in accordance with claim 1, wherein butane, propane, sulfur dioxide, hydrogen sulfide, acetylene, arsine, boron trichloride, boron trifluoride, butene, dichlorosilane, disilane, ethylene oxide, tetrafluoromethane, monochlorodifluoromethane, trifluoromethane, hexafluoroethane, tetrafluoroethene, isobutane, nitrogen dioxide, nitrogen trifluoride, nitric oxide, phosphine, propylene, silane, silicon tetrafluoride, silicon tetrachloride, sulfur tetrafluoride, tungsten hexafluoride, or any desired mixture of the aforementioned gases, with or without argon, is used as the isolating gas.

5. Method in accordance with claim 1, wherein a mixture of gases consisting of argon with admixtures of propane and/or butane is used as the isolating gas.
